(19) United States
(12) Patent Application Publication
(10) Pub. No.: US 2020/0320760 A1
(43) Pub. Date: Oct. 8, 2020

(54) METHOD AND SYSTEM FOR FORMING A COMPLEX VISUAL IMAGE

(71) Applicant: MAHOGANY SOLUTIONS PTY LTD, Hampton, Victoria (AU)

(72) Inventors: Andrew Kollmorgen, Hampton, Victoria (AU); Justin Harcourt-Horsfield, Hampton, Victoria (AU)

(21) Appl. No.: 16/320,159

(22) PCT Filed: Jul. 28, 2017
(86) PCT No.: PCT/AU2017/050790

§ 371 Date: Jan. 24, 2019

(30) Foreign Application Priority Data
Jul. 28, 2016 (AU) 2016902975

(51) Int. Cl. G06T 11/60; G06T 3/40; G06T 7/62; G06T 11/20

(52) U.S. Cl. CPC G06T 11/60; G06T 3/40; G06T 2200/24; G06T 11/203; G06T 7/62

(57) ABSTRACT

Creating a useable footprint complex image product, from an unscaled primary image by scaling the primary image and locking and tracking the scaled complex image product and combining and overlaying with matched scale selected secondary images.

### FIELD OF THE INVENTION

The present invention relates to a method and system for forming a complex visual image and in particular a complex image formed of overlay of multiple images.

The invention particularly relates to a method and system for scaleably controlling a visual image in order to form a complex image formed of overlay of multiple images.

In one form, it relates to a method and system for providing a useable variable footprint area of a visual image and to a method of determining and using measurable components in the variable footprint area and to a method and system for determining footprint area.

The invention has been developed primarily for use in/with two-dimensional real estate plans and will be described hereinafter with reference to this application. However, it will be appreciated that the invention is not limited to this particular field of use.

### BACKGROUND OF THE INVENTION

It is often necessary to form a complex image formed of overlay of multiple images. This is not readily achievable as the images are created separately and with no consideration of the other images. Therefore, random combination of such images will not form a final complex image with its component parts related to each other.

Use of computers in themselves will also not allow combination of images. A single image can be enlarged or shrunk. In essence the ready manoeuvrability of images by computers have caused the problem that the image that is transmitted or displayed or printed has no bearing on the size of the image when first created and therefore no determination of scaling.

Images are often published in a format that could be distinctly different to the format in which it was created. The original drawing could have been created by a local planner, or architect or designer at a particular scale. Therefore, the various components of the drawing are relatively scaled. The drawing can represent a plan view of a floor plan, or suburban street plan etc.

The problem is that the drawing could then be transmitted electronically and change in size in the transmission due to different screen sizes of the sender and receiver or due to different sized views of the files by the user compared to the sender. Still further the receiver can optionally enlarge the image to see it better or shrink it to fit in a presentation or further the scale can be changed when printed on various sized paper.

Therefore, even if the drawing is relatively scaled at inception, the actual scale of the image through its various display forms is not consistent and is no longer known. This means that other drawings which could have a particular scale or in themselves might have an unknown scale cannot be overlayed to form a combined scale.

Therefore, it can be seen that the usual computer transmission and display of images does not allow for combination of drawings without a clash of different scalings and often with unknown different scaling.

It can be that the drawing includes a scale in written form on the image. However, this is not a scale of the drawing image, but it is a relative comparative scale of the drawing to reality at the time the image was created. Therefore, on the original drawing 1 millimetre distance might have been equivalent to 1 metre in reality. The importance of this is the idea of the importance of ‘original architectural drawings which therefore maintains the exact scale. This does not allow transfer of scale with changes of image.

This is diagrammatically shown in FIG. 1 of the prior art in which a primary image 11 is required to form a basis for a complex image 15 by inclusion of secondary images 13 and 14. However the scale of the primary image is 1:? (i.e. it is unknown) and therefore the complex image scale is also 1:?. It therefore becomes impossible to add secondary images 13 and 14 which might have a known scale 1:10 and 1:20 but whether this matches the primary image 11 is totally unknown.

The physical result of this is that the furniture that is in one image when overlayed on a floorplan etc has no relevance to each other as the scaling merits of each image is not known and is in nearly all cases not in the same scale. If design work and furniture selection is then undertaken based on this incorrect information it is clear that in reality the design or furniture will not work in that location.

Overhead plan view photographs are a particular image that has an unknown scale. In geometry, the scale will be determined by the height above ground of the airplane, drone or helicopter from which the overhead plan photograph is taken. However detailed calculations would need to be taken on the ground and detailed reverse scaling calculations undertaken to determine the scale of the photograph as first taken.

However again that overhead plan view photograph is transformed into various sized images and the initial photograph has unknown scaling and the reproduction or different display forms of the image have even further different scaling.

It can be that a photograph or drawing is displayed with reference to a grid. However, this grid is merely a form of the relative comparative scale of the drawing to reality. It is not a grid that is relevant to the present scale of the image. Still further if another picture with grid is to be overlayed you cannot merely make the grids the same as there might be no relationship at all between grids.

Generally real estate is sold by a combination of pictures of the outside of the premises and a selection of pictures of various rooms in the premises. It is then completed by a two-dimensional floorplan or a site plan. In all of this there is no consistency of scale or understanding of actual dimensions.

If the building is being ‘bought off the plan then the sizing of the building needs to be matched to the sizing of the land. Also, the floorplan can show a room size but it is conceptually impossible to know exactly what that means in reality. This is even more prevalent when there is a limitation of space and rooms are downsized to make them fit but it is not until the fixtures and furniture are included in the final building that the size is understood.

If a residence is being sold without furniture or with undersized furniture or limited furniture in order to provide a pleasing spacious look then there will be a visual effect provided which distracts or even disguises the actual size disadvantages of the design and spacing.

Even further is that products at other locations such as your furniture from a previous residence, fixtures on display at kitchen or bathroom or plumbing supplies, furniture from shops etc are all either with real size or displayed in catalogues in their own individual scale or even in inconsistent scale in the same catalogue.

Still further is the online display. In this case the visual image is changeable all the time. There is no scale system as there is no fixed upload or download. It is impossible to keep track of a visual image from the start unless it is permanently locked into a display system. This totally prevents any merger of systems or overlap of pictures or the like. This permanently locked images stagnates the visual display and therefore is not an acceptable tool in commercial reality.

It is only an acceptable tool in dry precise fields such as strict map reading, precision engineering drawings and precision architectural drawings. Such are not for general use and are specially created for a single use.

It is known in the mapping and architectural services to have accurate drawings. However, this requires a single fixed source of image with the scale emblazoned on that single image. This requires every single image to individually have a scale. This precision for all visual images is not an acceptable, possible or affordable.

A particular problem is that if you are given this imprecise image with its unknown scale there is nothing you can do with it but to accept it on face value.

It can therefore be seen that there is a whole range of problems to be approached with at least one or more of those and other problems to be mitigated or ameliorated or at least provide an alternative.

Those problems include:
a) The problem of visual images not being in a known scale;
b) The problem of visual images changing scale when displayed online;
c) The problem of multiple visual images cannot be merged or used together as their individual scale is not known and the scales could be different;
d) The problem that visual images can provide visual effects that trick the viewer on size, scale, interrelation, perspective etc;
e) The usage of visual images can change from their inception with an intended use to a later use due to circumstances;
f) The visual image is visually judged;
g) The visual image cannot readily be measurably assessed;

It is to be understood that, if any prior art information is referred to herein, such reference does not constitute an admission that the information forms pa rt of the common general knowledge in the art, in Australia or any other country.

### SUMMARY OF THE INVENTION

The invention provides a method of controlling the display of an image including the steps of:
a) Allowing area measurement of at least part of a displayed varied scaled display by:
   i) Measuring the distance or area in the varied scaled display
   ii) Locking the relative XY plane of the display scale of the displayed image
   iii) Allowing variable scale of display of the visual image in the locked XY plane display scale
   iv) Automatically scaling the varied scaled display from the locked scale
   v) Monitor the change in the variable scale of display
   vi) Providing a virtual image blanket over an area
   vii) Determining the actual measured area in the varied scaled display by the monitored change in the variable scale of display from the locked scale

It can be seen that this system allows the user to both measure and furnish an existing floor plan without the need to initially re-create or re-draw the floor plan in any way.

In accordance with the invention there is provided a method for creating a complex image product, comprising:
a) Providing a computer system for receiving a primary image on which is to be formed a complex image product;
b) storing a library of a plurality of secondary images for use in the creation of the complex image product by the computer system;
c) receiving a command from a user with at least one relative scale dimension of a portion of the primary image;
d) scaling the primary image by the computer system to provide a determined scale;
e) locking the determined scale of the primary image to a display of the primary image;
f) providing the computer system with a scaling locking control which tracks the change of the scale of the primary image as the primary image display is changed;
g) automatically identifying one or more selected secondary images from the stored plurality of secondary images based on the input of user defined specification parameters for inclusion in the image product by the computer system;
h) modify the primary image display or the one or more selected secondary images to match the tracked locked scale of the primary image to the scale of the secondary images in the library;
i) and automatically create, by the computer system, a complex image product that incorporates at least some of the secondary images identified based on the specification parameters in combination with the primary image and with all at the same scale.

The secondary images in the library specify one or more image sources from which the images are to be obtained, wherein a scale is matched to each of the secondary images in the library wherein the step of automatically identifying comprises identifying images and its respective scale.

The identifying images can include
the one or more examples in the images of the one or more types of contents.
identifying images that are associated with the particular type of primary image.
identifying images that are taken from the selected range of the selected provider according to the user defined specification parameters.

The method can have the secondary images in the library specify one or more image product types, wherein one or more of the scales are matched to at least one specification term in the library that specifies an image product type, wherein the design for the image product is automatically created in the image product type.

The secondary images in the library can specify a recipient for an image product, wherein one or more of the scales are matched to a specification term in the library that specifies a recipient for an image product, wherein the physical manifestation of the image product is sent to the recipient after the step of manufacturing with the locked determined scale and is reproducible by the recipient with a tracked locked determined scale

Preferably the method further comprises selecting a subset of the identified secondary images, wherein a number of the identified images in the subset is within a predetermined scale compatible with the determined image product scale.

The user defined specification parameters can specify a style or a format for producing a final output complex image product, wherein one or more of the scales are matched to at least one specification term in the library that specifies a style or a format for the final output complex image product, wherein the design for the final output complex image product is automatically created in the style or the format

The method further comprises manufacturing a physical manifestation of the complex image product based on the user defined specification parameters design for the image product for display or printout.

The invention provides one or more of:
a method and system for providing a useable variable footprint area of a visual image
a method of determining and using measurable components in the variable footprint area
a method and system for determining footprint area,
or to at least improvements which will overcome or substantially ameliorate at least one or more of the deficiencies of the above or of the prior art,
or to at least provide an alternative.

In accordance with the invention there is provided a method for providing a useable variable footprint area of a visual image including the steps of:
a) Providing a visual image in an undefined scale;
b) Obtaining a measurement of a real dimension of at least a part of the visual image;
c) Measuring a corresponding dimension of at least a part of the visual image in the undefined scale;
d) Calculating the actual scale of the at least a part of the visual image; and
e) Locking the visual image in an undefined scale to relate to a locked scale in the corresponding actual scale; and wherein the image provides a useable variable footprint area of a visual image

The method can comprise the further steps of:
i) Providing a variable visual image expansion in consistentX and Y dimension scaling;
ii) Providing a linked expansion tracker for tracking percentage expansion of the variable visual image expansion in consistentX and Y dimension scaling from the locked scale;
iii) Determining the expanded scale from the locked scale
iv) Providing details of at least part of the visual image in the variable visual image expansion in consistentX and Y dimension scaling according to the determined expanded scale.

According to a further aspect of the present invention a method and system for determining footprint area is provided by providing an image layer of a visual 2 dimensional image to be measured and stretching a virtual footprint layer over the visual image layer and determining the area of the virtual footprint layer

It can be seen that the invention for determining footprint area provides the benefit of allowing use of using a method and system for providing a useable variable footprint area of a visual image in accordance with a preferred embodiment of the present invention such that the footprint area can be determined from unscaled visual image.

According to a still further aspect of the present invention, a method and system for determining footprint area is provided by determining the area of the virtual footprint layer by virtually dissecting into maximum sized polygons and determining area of each polygon and summing determined areas.

It can be seen that the invention for determining footprint area provides the benefit of not requiring layering over a predefined scaled array of predefined sized pixels which limits sizing and limits resolution and accuracy but instead allows free sizing and accurate mathematical sizing of unrestricted accuracy.

According to another aspect of the present invention, a method and system for determining footprint area is provided by scaling the determined summed area by scale measurement to determine actual footprint area.

In one form the invention provides a method of controlling the display of an image including the steps of allowing distance measurement of at least part of a displayed varied scaled display by:
i. Measuring the distance in the varied scaled display
ii. Locking the relative XY plane of the display scale of the displayed image
iii. Allowing variable scale of display of the visual image in the locked XY plane display scale
iv. Automatically scaling the varied scaled display from the locked scale
v. Monitor the change in the variable scale of display
vi. Determining the actual measured distance in the varied scaled display by the monitored change in the variable scale of display from the locked scale

The method of controlling the display of an image can further include the steps of:
allowing area measurement of at least part of a displayed varied scaled display by:
   i. Measuring the distance in the varied scaled display
   ii. Locking the relative XY plane of the display scale of the displayed image
   iii. Allowing variable scale of display of the visual image in the locked XY plane display scale
   iv. Automatically scaling the varied scaled display from the locked scale
   v. Monitor the change in the variable scale of display
   vi. Providing a virtual image blanket over an area
   vii. Determining the actual measured area in the varied scaled display by the monitored change in the variable scale of display from the locked scale;
wherein the method and system can be substantially assembled with improvements including any one or more of the following:
   i. improvements in structure and assembly
   ii. improvements in visual images being determined into a known scale;
   iii. improvements in tracking visual images in changing scale when displayed online even if not initially in known scale;
   iv. improvements in versatility of using multiple visual images such as being merged or used together as their individual scale is known even if the scales initially are different
   v. improvements in visual images providing visual effects that are understandable in size, scale, interrelation, perspective etc;
   vi. improvements in allowing the usage of visual images which can change use from their inception with an intended use to a later use due to circumstances;
   vii. improvements in allowing visual image to be visually judged;
   viii. improvements in the visual image being readily measurably assessed.

Also the invention can provide a method for creating a complex image product, which can provide a scaled visual image product for automatically determining linear or area dimensions of selected linear or area portions of the complex image comprising:
Providing a floorplan for inclusion into a computer system by scanning and forming a base image but without a known scale;
The system using a ruler to equate a known dimension in reality with an identified point to point on the drawing of the base image wherein the scale of the image is determined;
locking the now determined scale of the determined image online wherein any variation in the drawing will have a scale that is tracked with the changing of the drawing;
providing a plurality of secondary images in a store in the system which could be at a known scale;
overlaying the secondary images on the base image to form complex image product with both at the same scale by one or more of the steps of:
changing the scale of the tracked base image;
locking the scale of the secondary image and changing the scale of the tracked base image;
matching base image with selection of selected secondary images with same scale;
whereby there is consistency between the primary base image of the floorplan and the scale of the overlaying secondary images;
Providing a virtual line along a dimension or image blanket over an area
determining a length of a straight line as a ruler but instead of distance the blanket determines area by reference to the scale;
wherein the system allows the user to measure with an existing unscaled floor plan without the need to initially re-create or re-draw the floor plan in any way.

Other aspects of the invention are also disclosed.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 is a diagrammatic view of an unscaled primary display and secondary displays and difficulty of combining in the prior art;

FIGS. 2 and 3 are diagrammatic views of converting of primary display to a locked scaled display to determine a scale 1:X and then allow controlled expansion of display image to 1:A and follow changed scale rate to allow inclusion of secondary image at the followed scale matching the secondary image scale in accordance with an embodiment of the invention of creating a complex visual image;

FIG. 4 is a diagrammatic view of an unscaled display having an unscaled visual image and a locked scaled display of a scaled visual image using a method and system for providing a useable variable footprint area of a visual image in accordance with a preferred embodiment of the present invention;

FIG. 5 is a flow diagram of a method and system for providing a useable variable footprint area of a visual image in accordance with a preferred embodiment of the present invention;

FIG. 6 is a diagrammatic view of a varied tracked display having a varied tracked scaled visual image from the locked scaled display of a scaled visual image of FIG. 4 using a method and system for providing a useable variable footprint area of a visual image in accordance with a preferred embodiment of the present invention;

FIG. 7 is a method and system for providing a useable variable visual image in accordance with a preferred embodiment of the present invention;

FIG. 8 is a modified computer having input and output display for providing a varied tracked display having a varied tracked scaled visual image from the locked scaled display of a scaled visual image using a method and system for providing a useable variable footprint area of a visual image in accordance with a preferred embodiment of the present invention;

FIG. 9 is a diagrammatic view of the modified components of a system for providing a useable variable footprint area of a visual image in accordance with a preferred embodiment of the present invention; and

FIGS. 10 to 14 are connected diagrammatic view of the interconnection of a system for providing a useable variable footprint area of a visual image in accordance with a preferred embodiment of the present invention; and

FIGS. 15 to 23 are various pages of an app for implementing a method and system for providing a useable variable footprint area of a visual image in accordance with a preferred embodiment of the present invention.

### DESCRIPTION OF PREFERRED EMBODIMENTS

It should be noted in the following description that like or the same reference numerals in different embodiments denote the same or similar features.

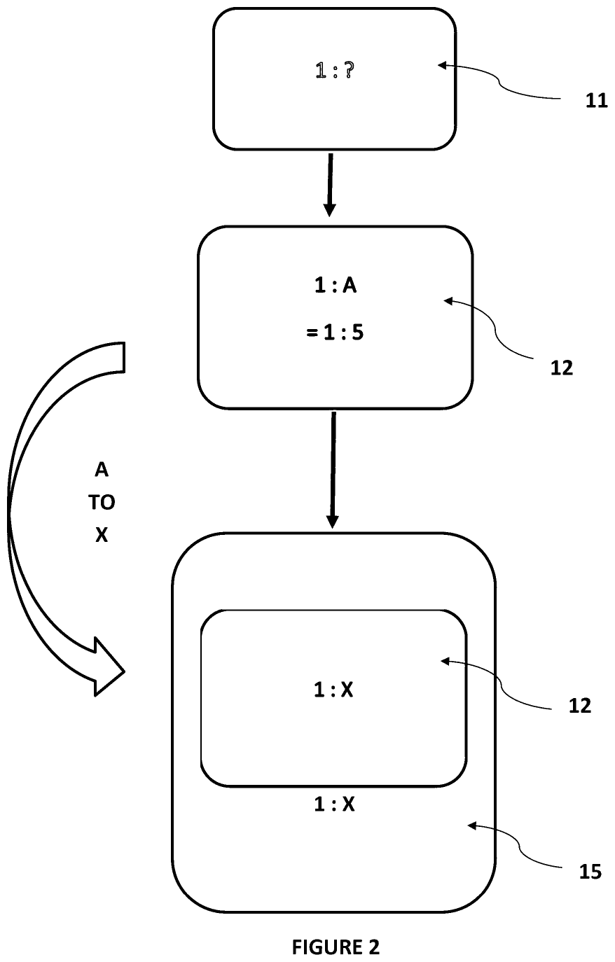

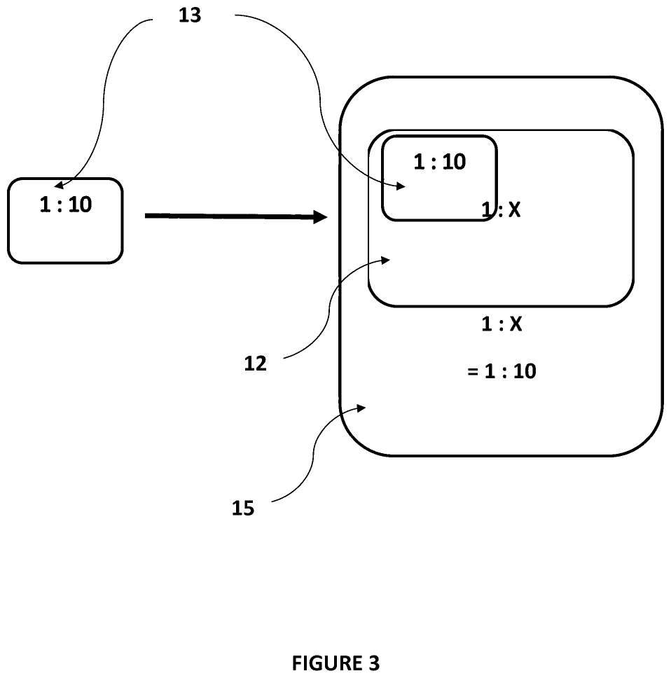

Referring to FIGS. 2 and 3 there is shown the effects of the method for creating a complex image product 15. This comprises providing a computer system for receiving a primary image 11 on which is to be formed a complex image product 15. However the primary image has an unknown scale 1:?.

There can be a plurality of secondary images 13, 14 which are to be included or are already storied in a library of a plurality of secondary images for use in the creation of the complex image product 15 by the computer system. These secondary images 13, 14 can be a range of contents or a range of furniture or a particular companys range of furniture.

Initially, as will be described more fully, the computer system receives a command from a user with at least one relative scale dimension of a portion of the primary image. This allows the computer system to scale the primary image from the unknown scale 1:? To a determined scale of 1:A.

The scale is then locked at the determined scale 1: A of the primary image 11 and can be set to a display of the primary image 11 to the locked scale primary image 12.

The computer system is programmed to provide a scaling locking control which tracks the change of the scale of the primary image as the primary image display is changed. The locked scale primary image 12 can then be sized to allow display on the display platform 15 at the required scale. That is the locked scale primary image 12 might fit onto a portion of a presentation page or as a house plan onto a display of a land site and therefore only take a portion of the display. However the display 15 and the locked scale primary image 12 have been transferred from initial locked scale of 1: A to the tracked locked scale of 1: X which then matches the locked primary image 12 with the display 15 at consistent 1:X.

From the user defined specification parameters for inclusion in the image product by the computer system, there is automatic identifying of one or more selected secondary images 13, 14 from the stored plurality of secondary images for the image. This can entail modifying the primary image display from 1:X to the 1:10 of the one or more selected secondary images 13 to match the tracked locked scale of the primary image to the scale of the secondary images in the library and then to automatically create, by the computer system, a complex image product that incorporates at least some of the secondary images identified based on the specification parameters in combination with the primary image and with all at the same scale.

The user defined specification parameters specify a style or a format for producing a final output complex image product, wherein one or more of the scales are matched to at least one specification term in the library that specifies a style or a format for the final output complex image product, wherein the design for the final output complex image product is automatically created in the style or the format

The method further creates a physical manifestation of the complex image product based on the user defined specification parameters design for the image product for display or printout.

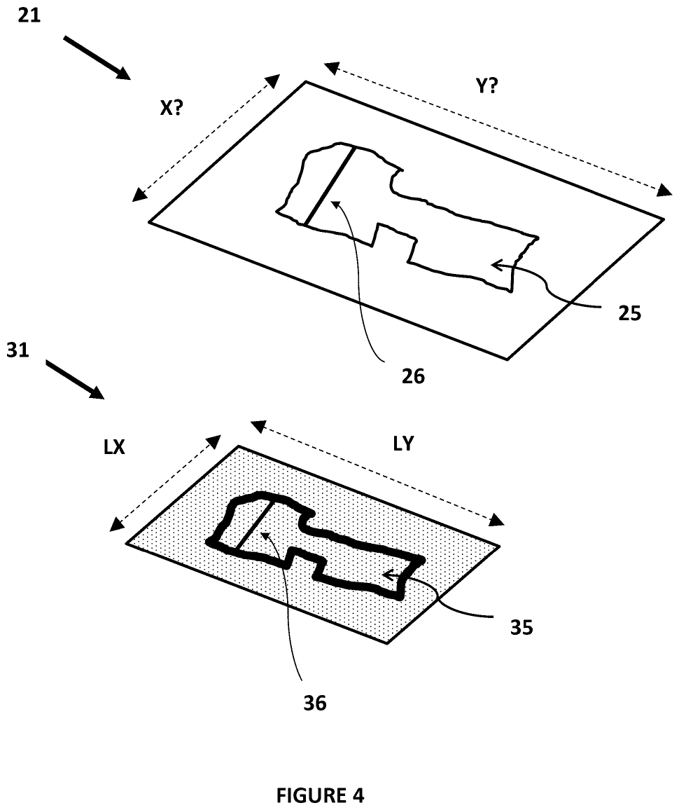

Looking at the process in more detail and referring to FIG. 4 there is a method and system for providing a useable variable footprint area of a visual image. This can be considered the visual plan aspect of the visual images to form the complex visual image product.

As shown in FIG. 4 the initial unscaled display 21 has an unscaled visual image 25 with unknown X-axis scale X? and an unknown Y-axis scale Y?. However, it is the result of the method using the system to arrive at a locked scaled display 31 of a scaled visual image 35 with known locked X-axis scale LX and known locked Y-axis scale LY. Clearly with the two-dimensional locked visual image 35 it is preferable that the locked X-axis scale LX and locked Y-axis scale LY are also locked relative to each other.

The method and system for providing a useable variable footprint area of a visual image can be used on a wide range of visual images which can be in a drawn or printed state or formed by a photograph and particularly a plan view photograph. The system can import the visual image as an image, PDF file (which gets converted automatically to an image), also a scanned image using the camera. The visual images in which it is important to have a scale but are often not presented in a usable scale or by photocopying reprinting etc. has not maintained its original scale can include:
a) a floorplan
b) a geographical plan
c) a map
d) a geographical boundary map
e) a site map
f) a site plan
g) a subdivision
h) a plan of subdivision
i) a single house plan
j) a multiple lot plan
k) a multiple unit plan
l) a development plan
m) a real estate marketing floor plan
n) architectural floor plans
o) engineering floor plans
p) town planning floor plans

The system can export the edited plan as an image or PDF. This can include modified inclusions such as furniture to the same scale.

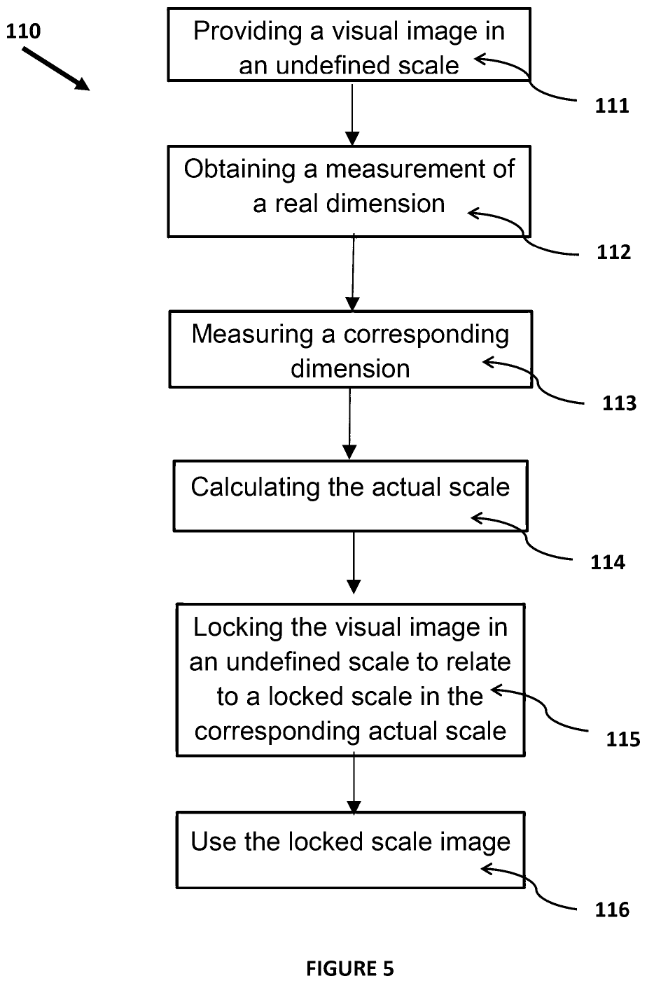

Looking at the method and system in detail and referring initially to FIG. 5 with reference to FIG. 4 there is the step 111 of providing a visual image 25 in an undefined scale on the unscaled display 21 and is therefore not in a usable form for any measuring or scaling uses.

By Step 112 a portion such as line 36 on the unscaled image 25 is used to obtain a measurement of a real dimension of at least a part of the visual image 25 and in Step 113 of measuring a corresponding dimension 26 of at least a part of the visual image in the undefined scale display 21 of the unscaled image 25. This can be used in Step 114 for calculating the actual scale of the at least a part of the visual image; and in Step 115 of locking the visual image 25 in an undefined scale X?-Y? to relate to a locked scale display 31 of the scaled image 35 in the corresponding actual scale LX-LY. This allows Step 116 of using the locked scale image 35

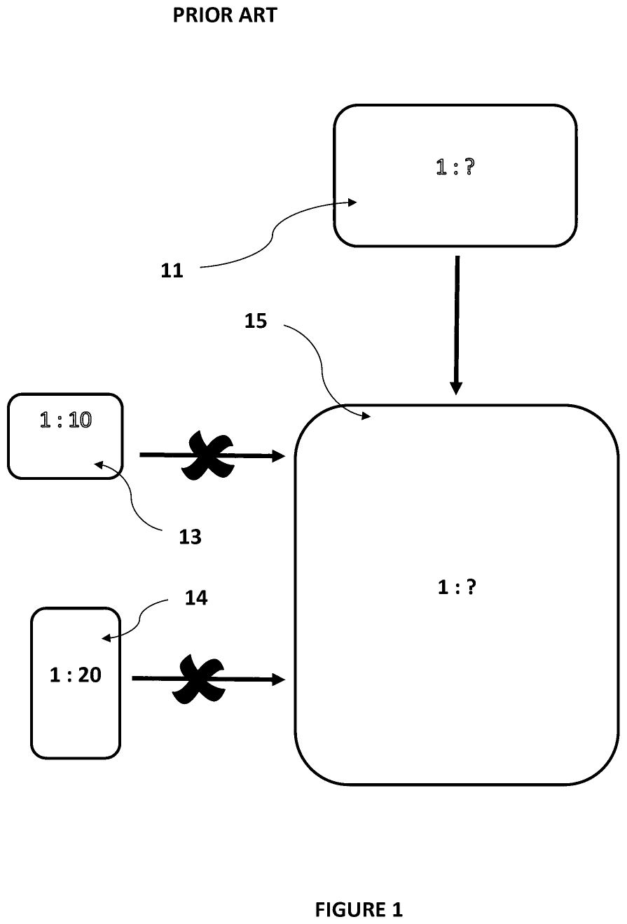

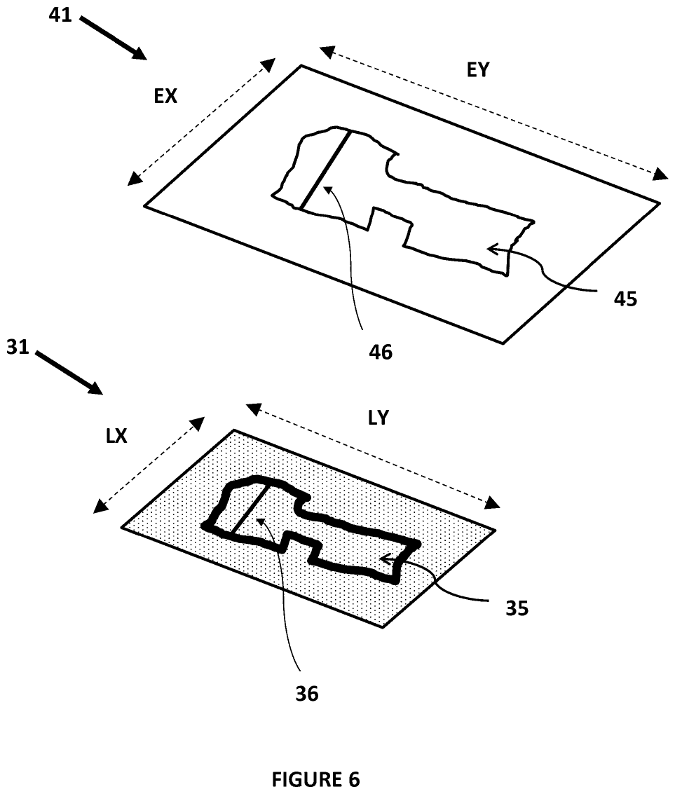

Referring to FIG. 6 there is provided by the method and system a varied tracked display 41 having a varied tracked scaled visual image 45 from the locked scaled display 31 of a scaled visual image 35 of FIG. 1. This can be used in any scale from thereon using the method and system for providing a useable variable footprint area of a visual image in accordance with a preferred embodiment of the present invention.

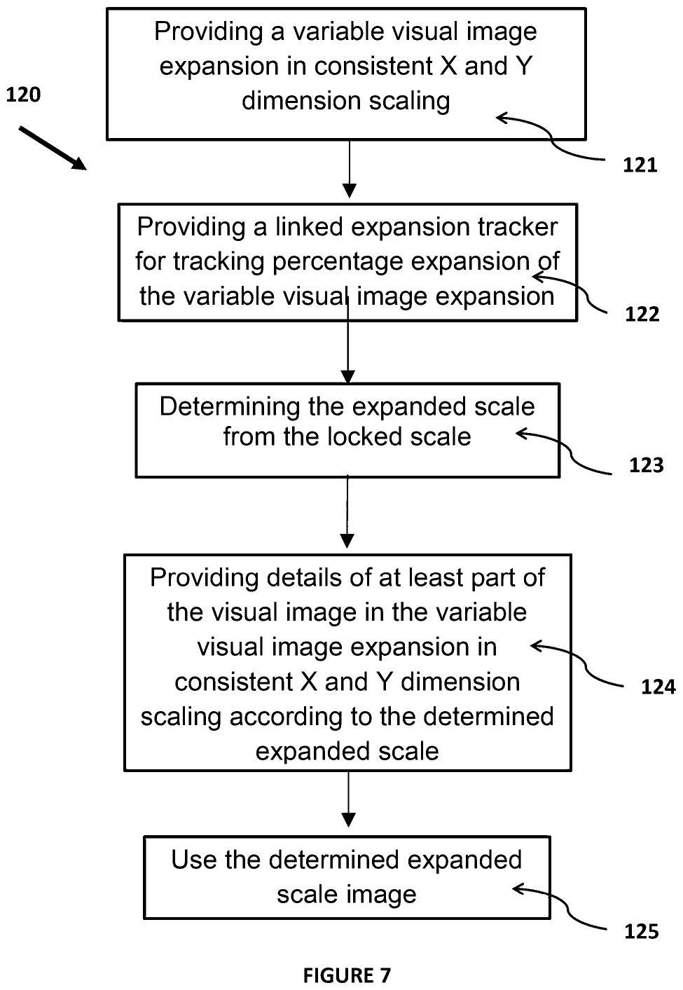

Referring to FIG. 7 with reference to FIG. 6 there is shown a method and system 120 for providing a useable variable visual image. This is achieved with the further step 121 of providing a variable visual image 45 expansion of the locked scaled image 35 in consistent known varied scaled X and Y dimension scaling EX-EY.

Step 122 provides the use of a linked expansion tracker 120 for tracking percentage expansion by a scaler 115 of the variable visual image 45 expansion in consistent X and Y dimension scaling from the locked scale visual image 35 and in Step 123 determining the expanded scale EX-EY from the locked scale LX-LY.

Step 124 allows providing details of at least part 46 of the variable visual image visual image 45 in the variable visual image expansion in consistent X and Y dimension scaling according to the determined expanded scale by the linked expansion tracker 120 for tracking percentage expansion by a scaler 115. This allows in step 125 using the determined expanded scaled image 41 for a range of uses.

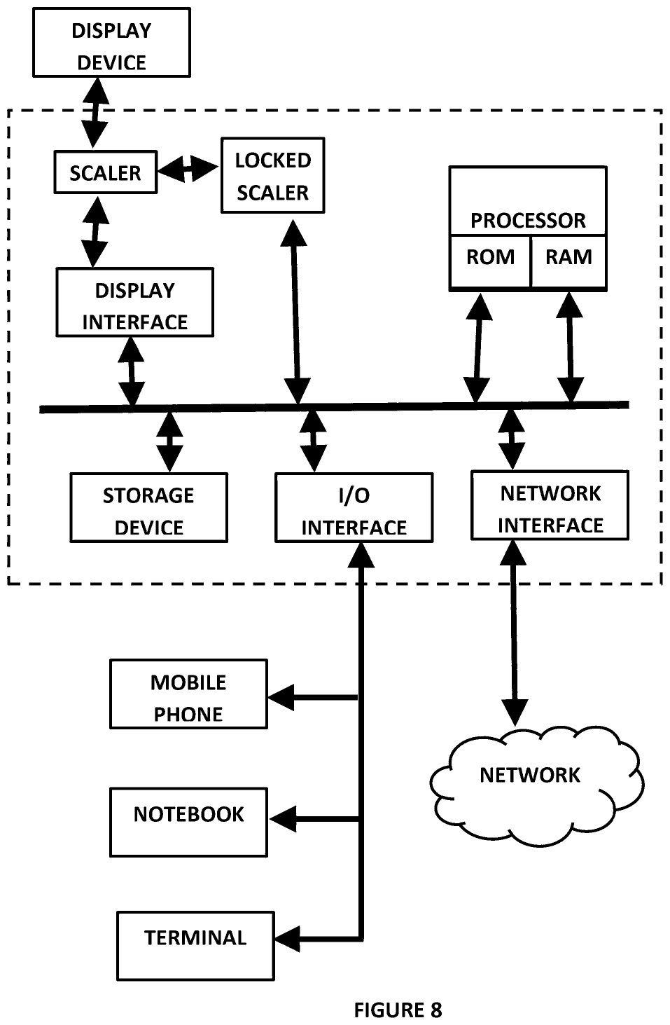

Referring to FIG. 8 there is a modified computer having input and output display and linked expansion tracker 120 for tracking percentage expansion by a scaler 115 for providing a varied tracked display having a varied tracked scaled visual image from the locked scaled display of a scaled visual image using a method and system for providing a useable variable footprint area.

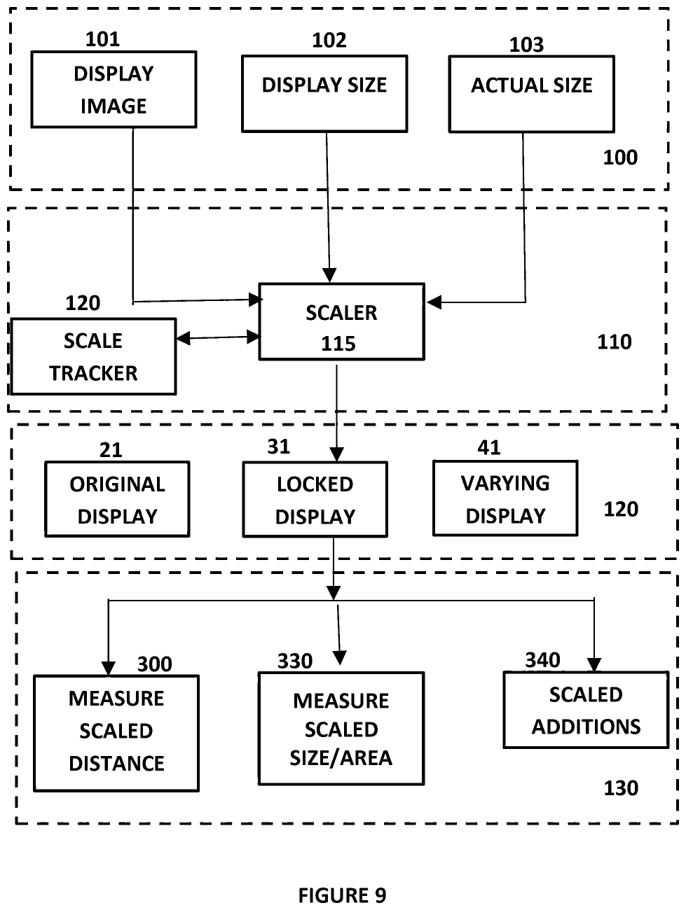

In FIG. 9 there is shown a conceptual block view of the modified components of a system for providing a useable variable footprint area of a visual image.

In particular in block 100 there are inputs such as display image input 101 for providing the unsca led visual image 25.

In block 110 there is the scaler 115 using the inputs 101, 102, 103 from the input module 100 linked expansion tracker 120 for tracking percentage expansion by a scaler 115 for providing a varied tracked display 41.

In block 120 there is the display block in which an original unscaled display 21 can be transformed to a locked scaled display 31 and used to form any varying scaled display 41 with the scaling block 110 maintaining control and oversight through the linked expansion tracker 120 for tracking percentage expansion by the scaler 115 for providing a varied tracked display.

In block 130 there are a number of uses of the display block 120 including on the display allowing measured scale distance 300 or measured scaled area 330 or by allowing addition or merger of other visual images in scaled format due to the ability to scale any unscaled visual image into a locked scaled image 31 and to any further varied scaled image 41. It can also be seen that changeability allows variations of accuracy and precision and detail to be selectively altered without limitation of display.

### Example A

In an initial example, a customer can come into a store, such as a furniture store, a plumbing supplies store, a renovation or design store, and provide a base drawing. This drawing can be of a floorplan of their residence and be inherently to scale relative to each component That is one wall is correctly scaled relatively to the other wall etc. However, the drawing itself has no scale. That is, it is impossible to know by looking at it—what scale is it? Further it could have been a reprint of a scaled drawing but by the printing the scale is again unknown.

This drawing of the floorplan of their residence can be included into the computer system by scanning. However still the scale is not known.

A ruler can be used to equate a known dimension in reality with an identified point to point on the drawing of the base image. In this way, the scale of the image is determined.

The ruler can be a physical or virtual ruler. However, it also could be a point to point linear calculation method or a drag along calculator virtual tape measurer or a virtual blanket that is stretched over a shaped area or other type of dimensioning tool.

An important element is that the now determined scale of the determined image online is locked. Therefore, any variation in the drawing will have a scale that is tracked with the changing of the drawing. In this way, the scale of the drawing remains known.

If the scale of the floorplan of their residence happens to be determined as 1:10 then there can be a plurality of secondary images in a store in the system which could be at a known scale of 1:20. Clearly it is not of any use to combine secondary images at scale of 1:20 over primary image of scale 1:10.

Therefore, the system can allow, with the locked scale system, the ready changing of the scale of the floorplan of their residence from 1:10 to 1:20 scale. Now there is consistency between the primary image of the floorplan and the scale of the secondary images of the furniture in the stored database.

In this form articles of furniture in diagram form as secondary images in the store in the system which could be at a known scale of 1:20 can be selected and dragged as an overlay over the primary image of the floorplan of their residence at the same known scale of 1:20 to form a complex image. The user then can see exactly in visual form how the furniture fits in and matches the floorplan. Further if the floorplan image has colouring and image details then the furniture can also be assessed aesthetically in the combined complex image.

It can be seen that this system allows the user to both measure and furnish an existing floor plan without the need to initially re-create or re-draw the floor plan in any way.

### Example B

In another example, the customer comes into a store without a floorplan.

The system can create a floorplan by any system including one or more of the following:
a) A database of standard shaped rooms;
b) A standard rectangular room that can be stretched to form the rectangular shape according to the customer;
c) A plurality of room components that can be selected and joined;
d) A drawing system that allows drawing of a floorplan.

Following this initial step or pre-step, the customer now has a floorplan. However, it is not to any known scale.

The further steps can then be followed of using a ruler to equate a known dimension in reality with an identified point to point on the drawing of the base image. In this way, the scale of the image is determined.

Then the now determined scale of the determined image online is locked. Therefore, any variation in the drawing will have a scale that is tracked with the changing of the drawing. In this way, the scale of the drawing remains known.

The system can allow, with the locked scale system, the ready changing of the scale of the floorplan of their residence from 1:10 to 1:20 scale. In this form articles of furniture in diagram form as secondary images in the store in the system which could be at a known scale of 1:20 can be selected and dragged as an overlay over the primary image of the floorplan of their residence at the same known scale of 1:20 to form a complex image.

The user then can see exactly in visual form how the furniture fits in and matches the floorplan. Further if the floorplan image has colouring and image details then the furniture can also be assessed aesthetically in the combined complex image.

### Example C

In a further example, the steps of pre-step of creating a floorplan or initial step of providing a floorplan without a known scale occurs. The image is uploaded and by use of a real or virtual ruler and with some information of a real dimension the scale is determined. This scale is then locked to this image such that changing of the image allows tracking of changing of the scale to a known scale such as 1:10.

However even though the scale of the primary image of the floorplan is known at 1:10 it can be that it does not match the secondary images of furniture which might be known to be at 1:20. However it could be that the scale of the secondary images are not known or are not presently in stored database at known scale.

Therefore, the secondary images can proceed through a process of the secondary images being uploaded and by use of a real or virtual ruler and with some information of a real dimension the scale is determined. This scale is then locked to these secondary images such that changing of the image allows tracking of changing of the scale to a known scale such as 1:20.

The step of matching the locked scale of the primary image to the locked scale of the secondary image can be by manipulating the primary image such that the locked scale tracks the changing of the primary image to maintain a known but changed scale of the primary image until it reaches the scale of 1:20 and thereby matches the secondary image.

Similarly, the step of matching the locked scale of the primary image to the locked scale of the secondary image can be by manipulating the secondary image such that the locked scale tracks the changing of the secondary image to maintain a known but changed scale of the secondary image until it reaches the scale of 1:10 and thereby matches the primary image.

With the primary and secondary images having the same locked scale (whether 1:10 in one form or 1:20 in the other form) by having them matched they can be overlayed at the same scale to provide a useful complex image.

### Example D

In another example, there can be the creation of a locked scale primary and/or secondary image or final complex image and then a computer process such as sending to a printer or transferring to another file or transmitting over a communication system. By the locking of the scale to the drawing the system can determine the transformation by the process and thereby maintain the drawing with a determined scale.

In a simple mode, the computer screen can be displaying an A4 page at 85% but then send to the printer for printing at actual A4 100% size. Therefore, the known scale of locked image on screen is in effect changed from 85% to 100% and the locked scale can follow that scale and determine the new scale of the image in the new format

Similarly, a locked scale image can be determined at one location on one computer and then be transmitted and the locked function follows the transformation and that the transmitted image maintains a locked known scale.

It is at this second location that other parts of the system of overlaying of secondary images over the transmitted primary image with matching of known locked scales controlled by the locking and tracking mechanism of the system.

### Example E

In another example, a person can present a floorplan that is not scaled. The image is uploaded and by use of a real or virtual ruler and with some information of a real dimension the scale is determined. This scale is then locked to this image such that changing of the image allows tracking of changing of the scale to a known scale such as 1:10. This allows the locked image to ne changed but having the locked scale follow the change and thereby always have a known scale to the image.

There can be the creation of a locked scale primary and/or secondary image or final complex image and then a blanket is dragged over a section of the image. This blanket is like a point to point drag in determining a length of a straight line as a ruler but instead of distance the blanket determines area. This can only be done by the image having been locked ata particular scale and an area calculation able to be undertaken of the image and then by the scale determined the actual area that the blanketed area represents.

The substantial benefit therefore is that the person arriving with the unscaled floorplan can then have the amount of area of carpeting or flooring needed and proper quotations achieved. It also allows visualization of the floorplan with the furniture or cupboards included and with colouring or textures included.

Also, there can be overlaying of blankets. This can be to include furniture or inbuilt cupboards or inbuilt kitchen island benches to be included as overlays in the complex image and the differences of the areas of the overlaying blankets used on the known scaled complex image to provide the accurate floor area that still requires tiles or floorboards or other flooring.

Application of a Preferred Embodiment.

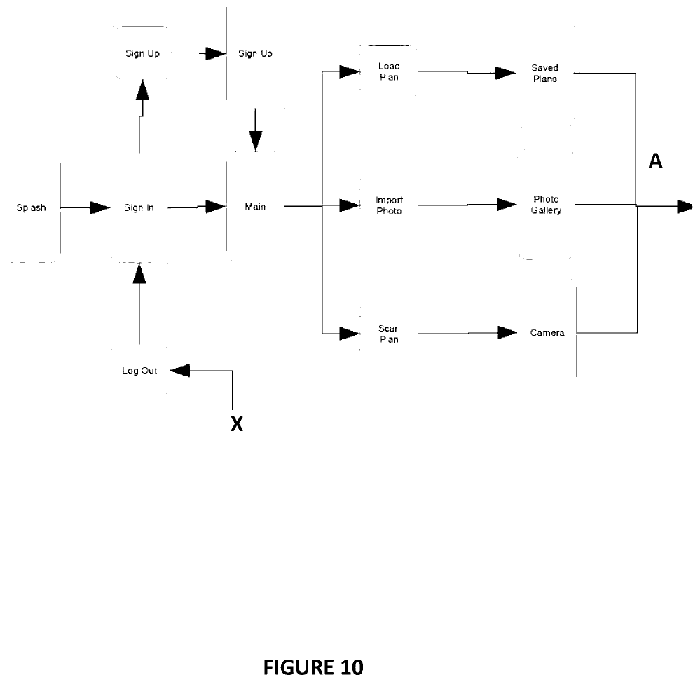

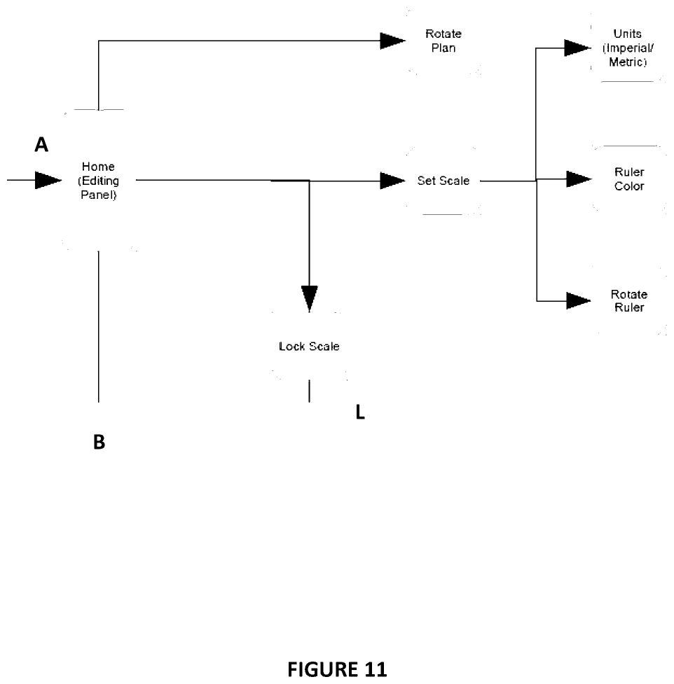

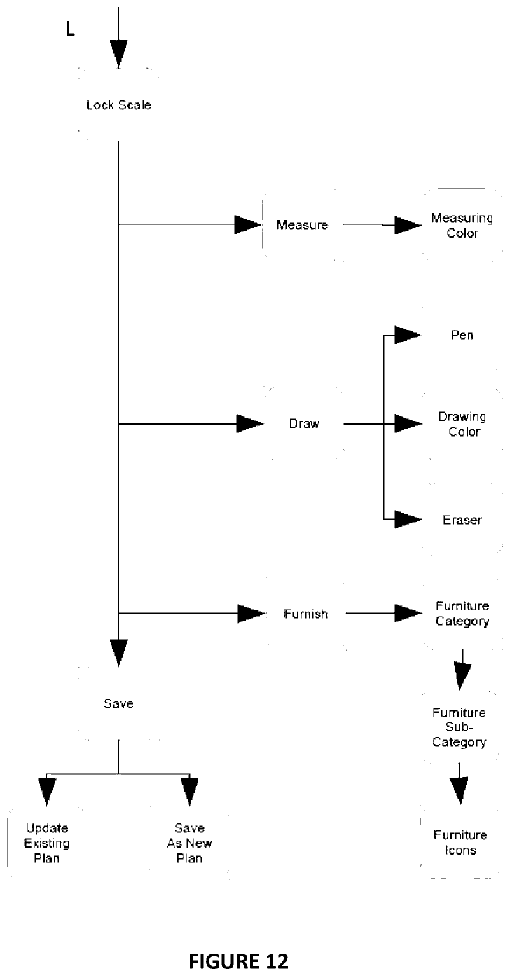

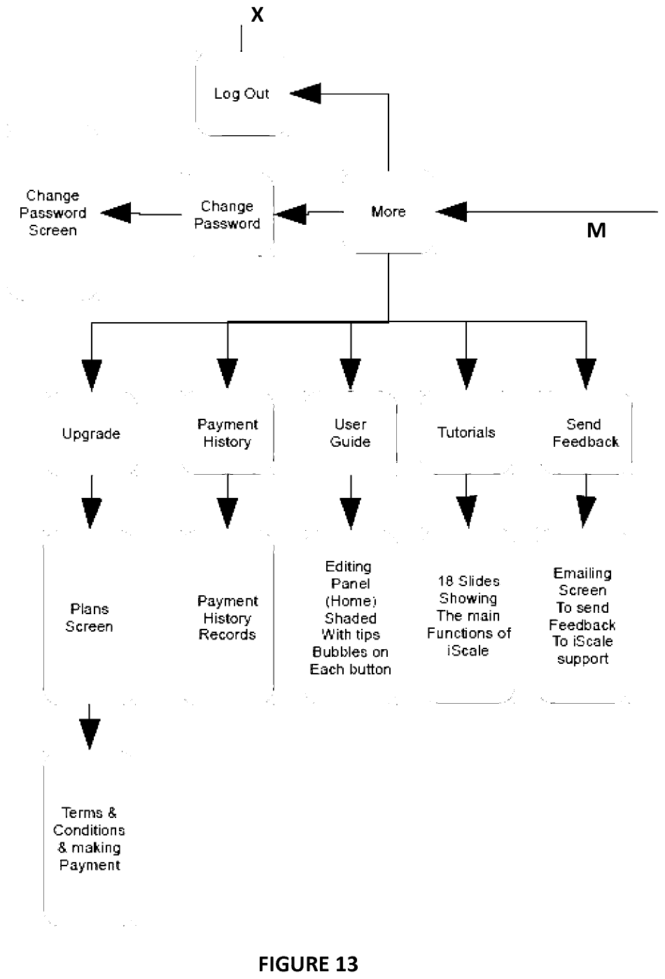

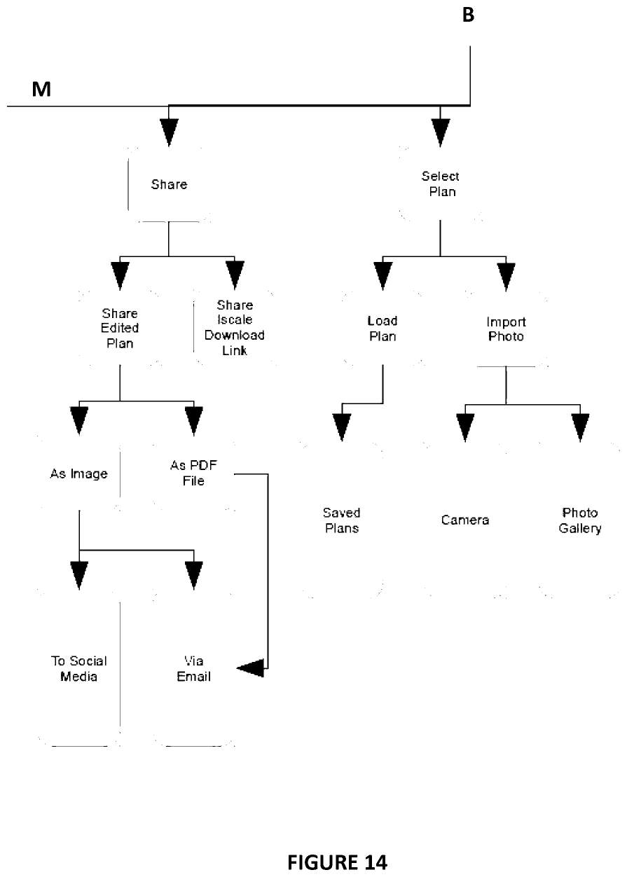

Referring to FIGS. 10 to 14 there is a connected wireframe of a computer application showing operation of a particular form of the invention in which
a) A in FIG. 10 connects to A in FIG. 11.
b) B in FIG. 11 connects to B in FIG. 14 and
c) L in FIG. 11 connects to L in FIG. 12.
d) X in FIG. 13 joins back to X in FIG. 10 and
e) M in FIG. 13 joins from M in FIG. 14.

In FIG. 10 it is shown that by initial connection to S plash the user can sign in and directly pass to the main menu if a member or divert through a sign up process before arriving at the main menu. At the main menu, the user can arrange inputs such as load plan which will then be saved online or import photo which will be saved to the photo gallery or scan plan by use of camera or the like.

In FIG. 11 there is the home editing panel in which a number of actions of those saved images can be manipulated such as by rotate plan or set scale or lock scale. These operations will be discussed further at later stage. In the set scale approach, there are the three elements of setting the units into imperial or metric, using a ruler on screen that has a particular colour so as to be used to define the measured line and rotating of that ruler to locate where it is required.

In FIG. 12 are the step of Lock Scale which can be saved or updated. However also it provides three options of allowing measuring and using colour to aid in the measurer. As well there can be drawing by use of online pen, colouring and online eraser. Also, there can be furnishing of the space with selection from online furniture category, and sub-category so that furniture icons in the locked scale can be added.

FIGS. 13 and 14 show further useful elements to the computer application.

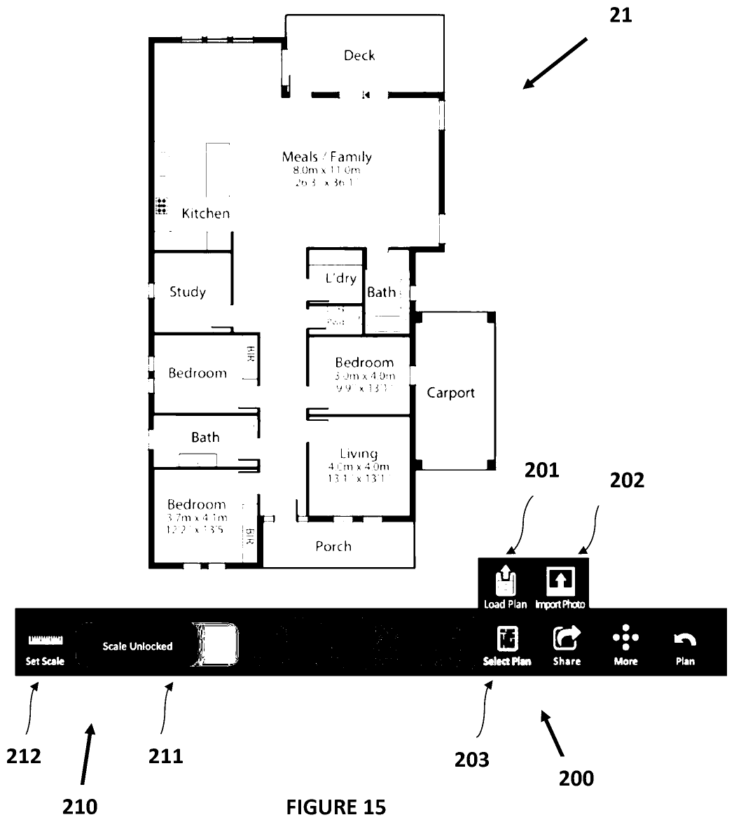

FIGS. 15 to 23 are various screenshot pages of a set of functions and procedures of applications which access the features or data of an operating system, application, or other service.an app for implementing a method and system for providing a useable variable footprint area of a visual image in accordance with an embodiment of the invention.

In FIG. 15 an unscaled visual image 21 which in this case is a real estate house floorplan can be uplifted and shown on a screenshot with a lower control bar. The control bar includes input controls 200 including button 201 for load plan instruction, and button 202 for import photo instruction and then ability by button 203 for select plan if various uploads have entered various unscaled images 21 to the memory. Also in the control bar are scale controls 210 including scale unlocked button 211 indicating that the image 21 is an unscaled image. There is further set scale instruction button 212 for controlling the process.

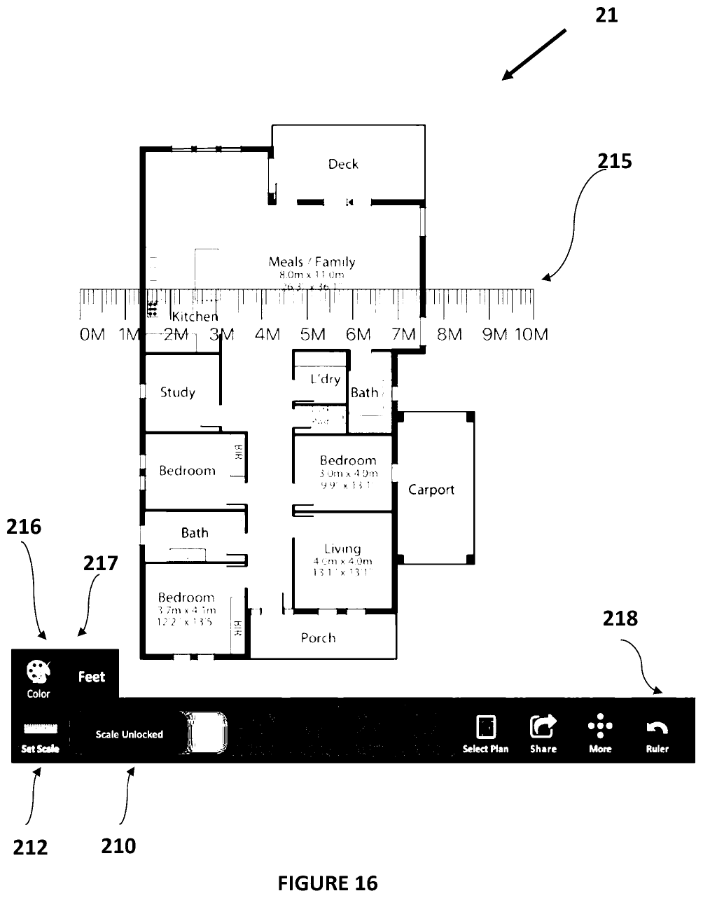

In FIG. 16 after the button 212 has instigated that action a ruler 215 is applied to the unscaled image 21 with buttons 216 able to adapt the colour from Red to another colour so that it is more readily visible over the image. The scale of the ruler 215 can be adapted by the ruler scale button 217 such as changing between Metric and Imperial scales. Also, there is button 218 allowing adaption of orientation of the ruler 215 on the display.

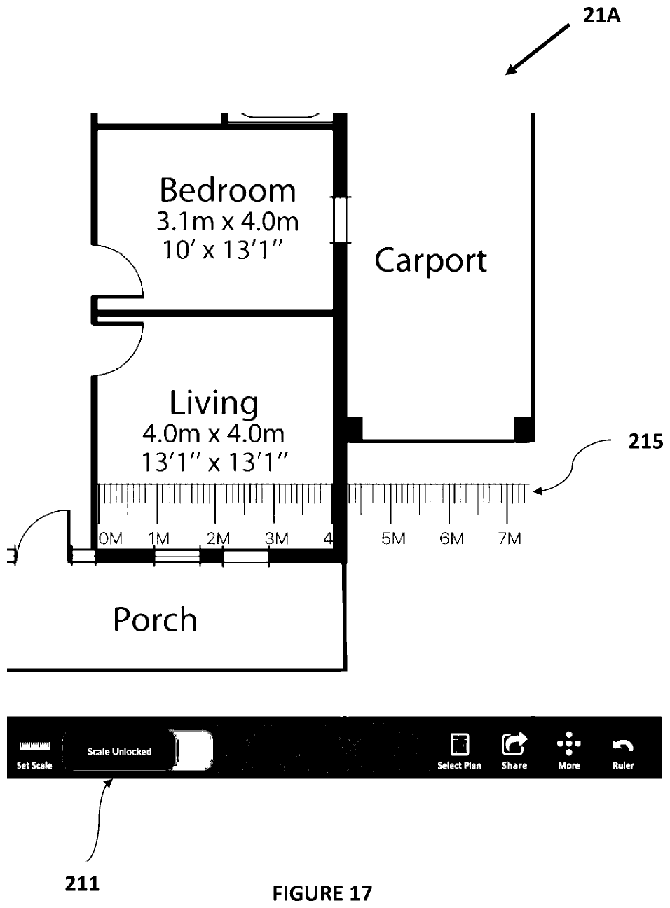

As shown in FIG. 17 the unscaled image 21 can be enlarged and a portion 21A shown on the scale with the ruler 215 overlaying the image. This can allow better accuracy in obtaining measurement and detail and that an ever-variable accuracy is possible to any unscaled image 21.

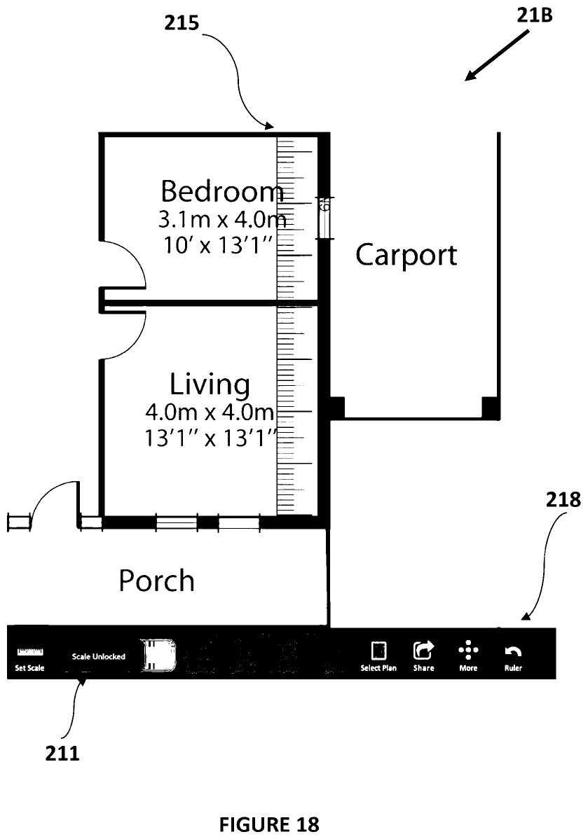

Further as shown in FIG. 18 by use of the button 218 it allows adaption of orientation of the ruler 215 to an orthogonal position relative to FIG. 14 and therefore measurement in an orthogonal axis of the display 21A. This can allow choice of measurement or increased accuracy in orthogonal axes.

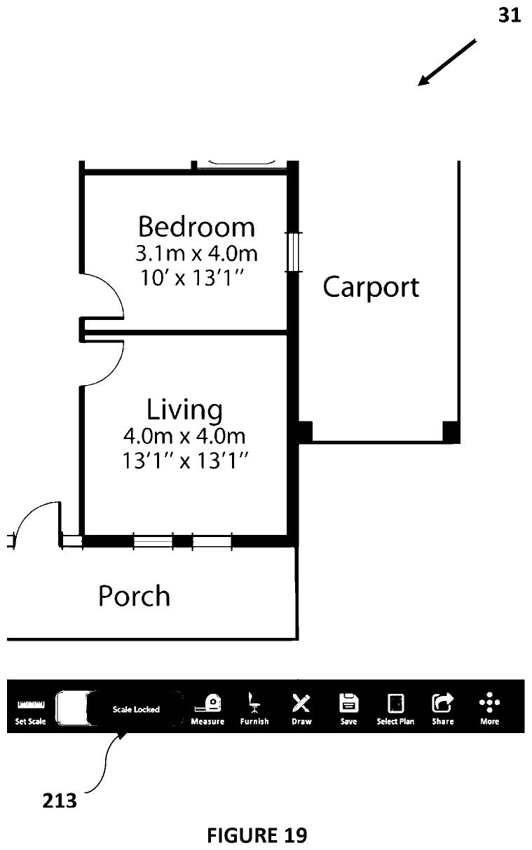

By application of that visual image scale to the matching measurement in reality the unscaled display 21 can become as shown in FIG. 19 a scaled display 31. This scaled display 31 is then locked as indicated by button 213 showing the scale locked. The image 31 then has a locked LX-LY scale in the X-axis and Y-axis and between each other.

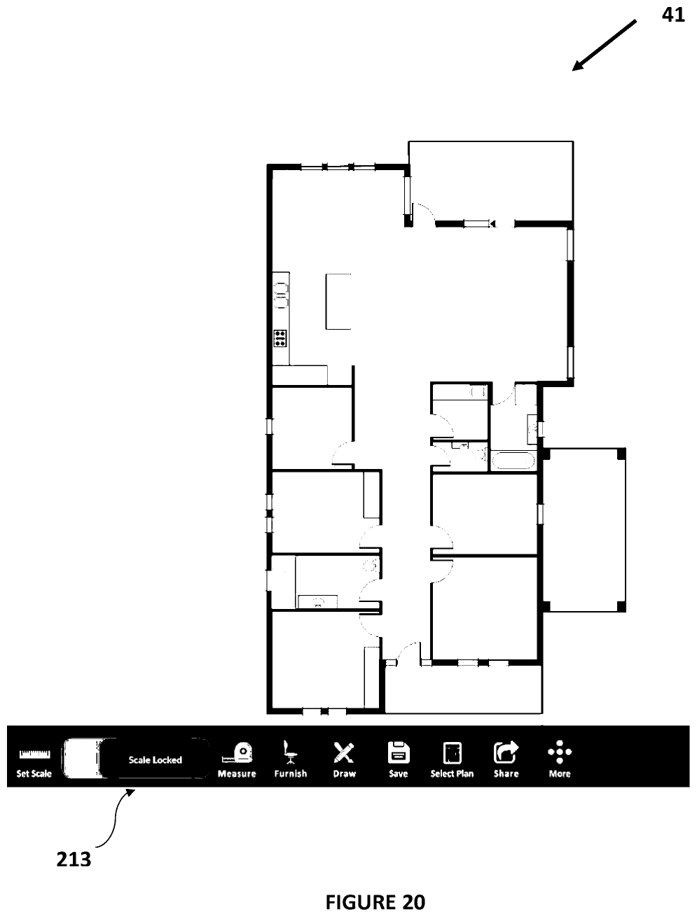

As shown in FIG. 20 the visual image 31 can be varied to a different varying scaled image 41 and displayed as such. However as shown by button 213 it is in a scaled locked format and therefore the linked expansion tracker 120 for tracking percentage expansion by a scaler 115 of the variable visual image 45 expansion in consistent X and Y dimension scaling from the locked scale visual image 35.

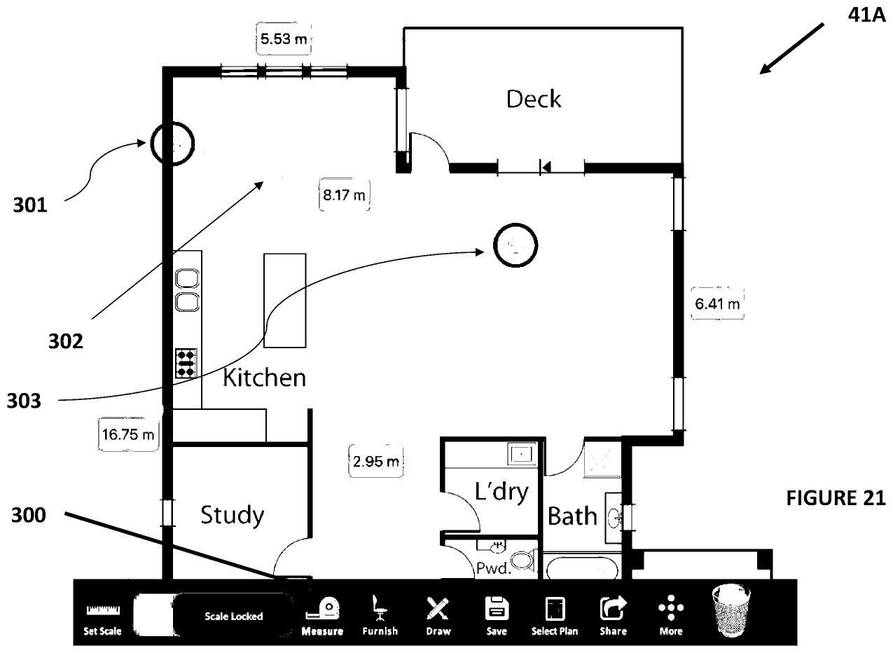

There can be multiple uses of such display. In FIG. 21 the display has again been modified to a different varying scaled design 41 but as per button 213 it is in scaled format with scale being tracked from the locked scale image 31. The display can have any two points 301 and 303 indicated anywhere on the varying scale display 41 in tracked variability locked scale format and a line 302 can be automatically determined and automatically calculated to the real-life measurement without the display 41 being in any fixed form. This allows better selection and use while maintaining accuracy and adaptability.

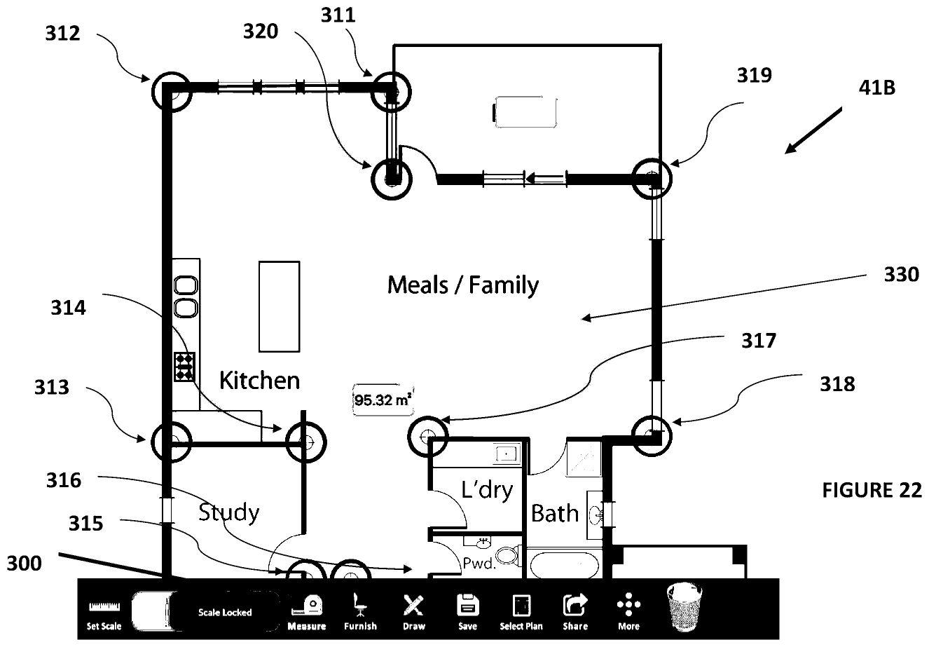

Referring to FIG. 22 there is shown a use of a method and system for providing a useable variable footprint area of a visual image by providing an image layer of a visual 2-dimensional image to be measured and stretching a virtual footprint layer 330 over the visual image layer 41 and determining the area of the virtual footprint layer. This virtual footprint layer can also be defined by clicking numerous points 311, 312, 313 u 320 and then the points are joined by the lines in-between and the area 330 between the in-between lines. This allows selection of various portions such as to determine the area that will be carpeted or the area with polished floorboards etc. This results in this case at 95.32 sq. metres.

In another form, the invention includes determining the area of the virtual footprint layer by virtually dissecting into maximum sized polygons and determining area of each polygon and summing determined areas.

Further there can be still another form of the invention which includes scaling the determined summed area by scale measurement to determine actual footprint area.

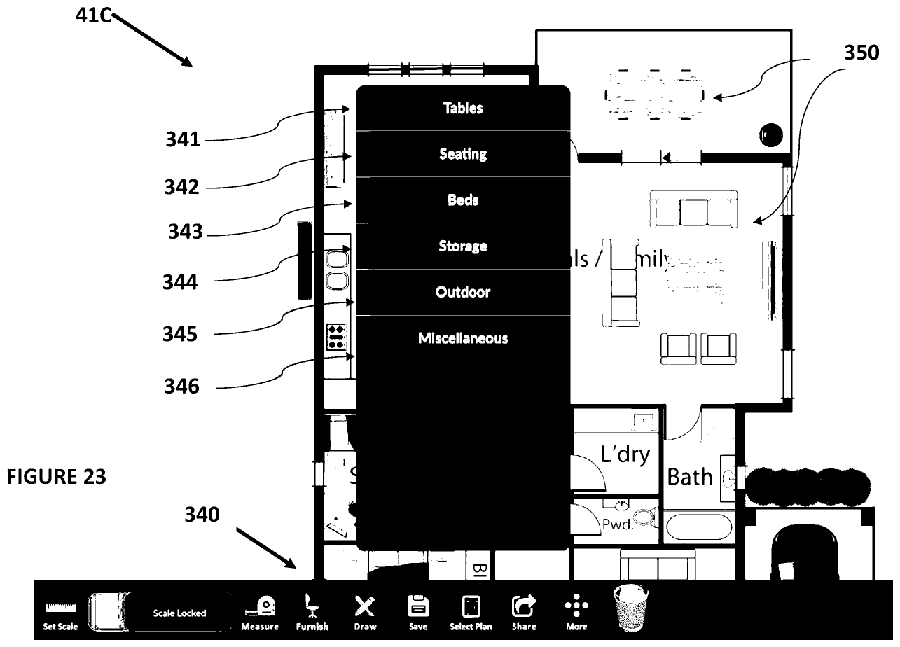

As shown in FIG. 23 by instigation of control button 340 a range of furniture inputs 341 to 346 can appear so that the varying scaled image detail 41C such as one or more rooms can be furnished. Since the image 41C is a varying scale image it must be in the tracked varying locked scale format as shown by button 213. Further the furniture can be in their tracked varying locked scale format by previous uploads or in a library and button 340 allows the merger of these separately scaled images 41A, 41B or 41C to be formed into matching scale EX-EY regardless of the varying scale of the varying scaled image 41A. That is the images are scaled accordingly, matched and merged without needing to be bound by matching input displays or input scales.

Clearly it is shown that the present invention provides a technical improvement to displays and their creation and implementation that is aimed at overcoming or ameliorating one or more of the multitude of problems of the prior art.

Therefore, it can be seen that the invention determines a scale of a floor plan in the form of a visual image, regardless of its size or dimensions. By knowing the exact length of a particular part of that image, regardless of its direction and regardless of its location on the image, the system can use a ruler (scaler) with unified dimensions and the user use the ruler to input the length of any part of the visual image which is used to determine scale. If the ruler is reduced in size by 20% then the visual image is called 20% smaller than the ruler and vice versa.

To obtain scale S here is the following requirement of:

S=X*(RN/RO)

The scaler is set with fixed width RO (ruler original width) and is divided in scale along its length to a scale X (metre on the ruler). When the ruler is used its width is either increased or reduced and to maintain relative dimension has width R N (ruler new width). The measuring unit on the screen can be the pixels so a goal is to translate pixels into metres.

If R O=1000 and X=100 but R N=2000,
then S=100*(2000/1000)=100′2=200
   This means for that image, each metre will occupy 200 pixels, instead of the 100 pixels.

When a user wishes to undertake linear measurement, the user sets 2 points on the screen and wants to know the actual distance, the system determines the pixels and provides DM (distance measured). In this case the equation is:

DS=(DM/S).

This is achieved due to the locked scale and the distance of the set points.
DM=400 pixels S=200 pixels
   therefore DS=400/200=2 metres.

When a user wishes to undertake area measurement, the user sets a few points on the screen and wants to know the area between them, the system determines the pixels and provides AM (area measured). In this case the equation is:

AS=((AM)/(S*S)).

This is achieved due to the locked scale and the distance of the set points.
AM=80000 pixels S=200 pixels
   therefore AS=80000/(200*200)=2 metres squared.

Furniture icons are stored and the icons dimension maintain the same aspect ratio. When a user wishes to use furniture, the user selects a piece of furniture such as a dining table which is 2 by 1 metres. The icon originally would be 20*10 pixels.

Due to the locked scale S the furniture icon width FWO is scaled to the new width FWS by:

FWS=FWO*S

And similarly furniture icon height FHO is scaled to the new width FHS by

FHS=FHO*S

So with FWO=2 metres and FHO=1 metre and S=200 pixels
therefore FWS=2′200=400 pixels and

FHS=1′200=200 pixels.

This is using the pixel method but other methods can be used.

### Interpretation

### Embodiments

Reference throughout this specification to ‘one embodiment or ‘an embodiment means that a particular feature, structure or characteristic described in connection with the embodiment is included in at least one embodiment of the present invention. Thus, appearances of the phrases ‘in one embodiment or ‘in an embodiment in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives ‘first, ‘second, ‘third, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth.

However, it is understood that embodiments of the invention may be practiced without these specific details. In other instances, well-known methods, structures and techniques have not been shown in detail in order notto obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word ‘comprise or variations such as ‘comprises or ‘comprising are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the geographical and real estate and graphical display industries as well as to the home improvement industry including DIY supplies, furniture and home goods.

1-28. (canceled)

29. A method for creating a complex image product, comprising:
a. providing a computer system configured to receive a primary image on which is to be formed a complex image product;
b. storing a library of a plurality of secondary images for use in the creation of the complex image product by the computer system;
c. receiving a command from a user with at least one relative scale dimension of a portion of the primary image;
d. scaling the primary image by the computer system to provide a determined scale;
e. locking the determined scale of the primary image to a display of the primary image;
f. providing the computer system with a scaling locking control configured to track the change of the scale of the primary image as the primary image display is changed;
g. automatically identifying one or more selected secondary images from the stored plurality of secondary images based on the input of user defined specification parameters for inclusion in the image product by the computer system;
h. modifying the primary image display or the one or more selected secondary images to match the tracked locked scale of the primary image to the scale of the secondary images in the library; and
i. automatically creating, by the computer system, a complex image product that incorporates at least some of the secondary images identified based on the specification parameters in combination with the primary image and with all at the same scale,
j. wherein the secondary images in the library specify one or more image product types, wherein one or more of the scales are matched to at least one specification term in the library that specifies an image product type, wherein the design for the image product is automatically created in the image product type.

30. The method of claim 29, wherein the visual image is one of:
a. a floorplan
b. a geographical plan
c. a map
d. a geographical boundary map
e. a site map
f. a site plan
g. a subdivision
h. a plan of subdivision
i. a single house plan
j. a multiple lot plan
k. a multiple unit plan
l. a development plan
m. a real estate marketing floor plan
n. architectural floor plans
o. engineering floor plans
p. town planning floor plans.

31. The method of claim 29, wherein the secondary images in the library specify a recipient for an image product, wherein one or more of the scales are matched to a specification term in the library that specifies a recipient for an image product, wherein the physical manifestation of the image product is sent to the recipient after the step of manufacturing with the locked determined scale and is reproducible by the recipient with a tracked locked determined scale.

32. The method of claim 29, further comprising:
selecting a subset of the identified secondary images, wherein a number of the identified images in the subset is within a predetermined scale compatible with the determined image product scale.

33. The method of claim 29, wherein the user defined specification parameters specify a style or a format for producing a final output complex image product, wherein one or more of the scales are matched to at least one specification term in the library that specifies a style or a format for the final output complex image product, wherein the design for the final output complex image product is automatically created in the style or the format.

34. The method of claim 29, further comprising:
manufacturing a physical manifestation of the complex image product based on the user defined specification parameters design for the image product for display or printout.

35. A method for creating a complex image product including for providing a useable variable footprint area of a visual image including the steps of:
a. providing a visual image in an undefined scale;
b. obtaining a measurement of a real dimension of at least a part of the visual image;
c. measuring a corresponding dimension of at least a part of the visual image in the undefined scale;
d. calculating the actual scale of the at least one part of the visual image; and
e. locking the visual image in an undefined scale to relate to a locked scale in the corresponding actual scale,
wherein the image provides a useable variable footprint area of a visual image for determining a footprint area of a visual image comprising the further steps of:
f. providing a variable visual image expansion in consistent X and Y dimension scaling;
g. providing a linked expansion tracker configured to track percentage expansion of the variable visual image expansion in consistent X and Y dimension scaling from the locked scale;
h. determining the expanded scale from the locked scale;
i. providing details of at least part of the visual image in the variable visual image expansion in consistent X and Y dimension scaling according to the determined expanded scale;
for determining the footprint area of a visual image using:
j. a visual image capturer for capturing a visual image in two dimensions;
k. a visual image display having:
i. a first display layer for displaying the captured visual image, and
ii. a second display layer for displaying an overlaying measuring virtual image blanket layer;
l. a virtual image blanket for selecting and displaying in the second layer to overlay the visual image in the first layer
m. a virtual image blanket manipulator configured to manipulate the size and shape of the overlaying of the virtual image blanket, wherein the virtual image blanket manipulator can grab points on the circumference of the virtual image blanket and drag and extend the virtual image blanket to the required overlaying boundaries of the virtual image on the layer below; and
n. an area determinator configured to determine the area of the virtual blanket.

36. A method for creating a complex image product including for providing a useable variable footprint area according to claim 35 wherein the visual image is one of:
a. a floorplan
b. a geographical plan
c. a map
d. a geographical boundary map
e. a site map
f. a site plan
g. a subdivision
h. a plan of subdivision
i. a single house plan
j. a multiple lot plan
k. a multiple unit plan
l. a development plan
m. a real estate marketing floor plan
n. architectural floor plans
o. engineering floor plans
p. town planning floor plans.

37. A method for creating a complex image product including for providing a useable variable footprint area according to claim 36 further comprising a virtual image blanket menu enabling a virtual image blanket to be selected from the menu of possible basic geometric shapes including at least one or more of:
a. triangle
b. rectangle
c. pentagon
d. circle
e. ellipse
f. crescent
further comprising the area determinator configured to determine the area of the virtual footprint layer having a virtual visual image dissector of the virtual image blanket by virtually dissecting into maximum basic geometric shapes and determining area of each basic geometric shapes and summing determined areas.

38. An apparatus for determining a footprint area according to claim 37 further comprising the area determinator having a plurality of equations for determining areas of at least a preselected number of basic geometric shapes.

39. An apparatus for determining a footprint area according to claim 38 further comprising scaling the determined summed area by scale measurement to determine actual footprint area.

40. A method for creating a complex image product including for providing a useable variable footprint area according to claim 7 comprising the steps of:
a. capturing an image;
b. displaying the captured image in a first layer;
c. providing a virtual image blanket and displaying in a second overlaying layer;
d. manipulating the virtual image blanket to overlay the required footprint area of the visual image;
e. determining the area of the virtual image blanket,
wherein the step of determining the area of the virtual image blanket includes:
i. selecting a basic geometrical shape as that closely represents the required footprint area of the visual image as the shape of the virtual image blanket;
ii. manipulating the virtual image blanket to fully overlay while substantially retaining the general shape of the selected basic geometrical shape,
wherein the step of determining the area of the virtual image blanket includes:
i. providing a library of a plurality of equations for determining areas of at least a preselected number of the basic geometric shapes;
ii. matching the selected basic geometrical shape with relevant equations to determine the area of basic geometrical shape;
iii. dissecting the remainder of the virtual image blanket not covered by the selected basic geometrical shape into further ones of basic geometrical shape;
iv. matching the further basic geometrical shapes with relevant equations to determine the area of the further basic geometrical shape; and
v. summing the determined areas of the basic geometric shapes to determine the area of the virtual image blanket.

41. A method and system for determining a footprint area according to claim 40 wherein the step of determining the area of the virtual image blanket includes scaling the determined summed area by scale measurement to determine actual footprint area.

42. A method of controlling the display of an image including the steps of:
a. providing a display of an image;
b. determining a scale of the displayed image and determining a locked scale;
c. locking the relative XY plane of the display scale of the displayed image;
d. allowing variable scale of display of the visual image in the locked XY plane display scale;
e. monitoring the change in the variable scale of display; and
f. providing the determination of the variable scale by the monitored change in the variable scale from the locked scale.

43. A method of controlling the display of an image according to claim 42 further including the steps of:
a. allowing distance measurement of at least part of a displayed varied scaled display by:
i. measuring the distance in the varied scaled display,
ii. locking the relative XY plane of the display scale of the displayed image,
iii. allowing variable scale of display of the visual image in the locked XY plane display scale,
iv. automatically scaling the varied scaled display from the locked scale,
v. monitoring the change in the variable scale of display, and
vi. determining the actual measured distance in the varied scaled display by the monitored change in the variable scale of display from the locked scale.

44. A method of controlling the display of an image according to claim 42 further including the steps of:
a. allowing area measurement of at least part of a displayed varied scaled display by:
i. measuring the distance or area in the varied scaled display,
ii. locking the relative XY plane of the display scale of the displayed image,
iii. allowing variable scale of display of the visual image in the locked XY plane display scale,
iv. automatically scaling the varied scaled display from the locked scale,
v. monitoring the change in the variable scale of display,
vi. providing a virtual image blanket over an area, and
vii. determining the actual measured area in the varied scaled display by the monitored change in the variable scale of display from the locked scale.

45. A method of controlling the display of furniture or objects on an image according to claim 43 further including the steps of:
a. allowing area measurement of furniture or objects at least part of a displayed varied scaled display by:
i. measuring the distance or area of the furniture or objects in the varied scaled display,
ii. locking the relative XY plane of the furniture or objects,
iii. determining the locked display scale of the displayed visual image,
iv. allowing variable scale of display of the furniture or objects in the locked XY plane display scale,
v. automatically scaling the varied scaled display furniture or objects from the variable scale of display to a locked scale matching the locked display scale of the displayed visual image, and
vi. displaying the locked varied scaled display of the furniture or objects in the locked variable scale of display of the visual image both in the same locked scale.

46. A method for creating a complex image product according to claim 29, which can provide a scaled visual image product for automatically determining linear or area dimensions of selected linear or area portions of the complex image, the methof comprising:
a. providing a floorplan for inclusion into a computer system by scanning and forming a base image but without a known scale;
b. the system using a ruler to equate a known dimension in reality with an identified point to point on the drawing of the base image wherein the scale of the image is determined;
c. locking the now determined scale of the determined image online wherein any variation in the drawing will have a scale that is tracked with the changing of the drawing;
d. providing a plurality of secondary images in a store in the system which could be at a known scale;
e. overlaying the secondary images on the base image to form complex image product with both at the same scale by one or more of the steps of:
i. changing the scale of the tracked base image;
ii. locking the scale of the secondary image and changing the scale of the tracked base image; and
iii. matching the base image with selection of selected secondary images with same scale;
whereby there is consistency between the primary base image of the floorplan and the scale of the overlaying secondary images;
f. providing a virtual line along a dimension or image blanket over an area; and
g. determining a length of a straight line as a ruler but instead of distance the blanket determines area by reference to the scale.
